(19) United States
(12) Patent Application Publication
(10) Pub. No.: US 2026/0229908 A1
(43) Pub. Date: Aug. 6, 2026

(54) POWER CONVERSION SYSTEM WITH INVERTER FOR PRE-CHARGE AND DISCHARGE OPERATIONS

(71) Applicant: GM Global Technology Operations LLC, Detroit, MI (US)

(72) Inventors: Yilun Luo, Ann Arbor, MI (US); Khorshed Mohammed Alam, Canton, MI (US); Muhammad Ahsan Zahid, Troy, MI (US); Mazharul Chowdhury, Canton, MI (US); Ajay Mehta, Clarkston, MI (US); Varoun Perumal, Novi, MI (US); Chandra S. Namuduri, Troy, MI (US)

(73) Assignee: GM Global Technology Operations LLC, Detroit, MI (US)

(21) Appl. No.: 19/042,389

(22) Filed: Jan. 31, 2025

(51) Int. Cl. H02M 7/5387; B60L 50/40; B60L 50/51; B60L 50/60; B60L 53/20; H02J 7/00; H02J 7/34; H02J 50/10

(52) U.S. Cl. CPC H02M 7/5387; B60L 50/40; B60L 50/51; B60L 50/60; B60L 53/20; H02J 7/345; H02J 7/855; H02J 50/10; B60L 2210/40; H02J 2207/50

(57) ABSTRACT

An inverter includes an electric line coupling a positive node of the battery to a negative node of the battery, and a rotor electric line coupling the electric line to the rotor. The inverter further includes a first relay disposed on the electric line, a second relay disposed on the rotor electric line, a capacitor and a charging circuit. The charging circuit is configured to perform a discharging and a pre-charging operation wherein in a discharging operation, the capacitor is discharged through the rotor and in a pre-charging operation, electric power from the battery is transmitted through the rotor prior to the capacitor to limit an inrush of current to the capacitor.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates generally to a power conversion system including an inverter configured to perform pre-charge and discharge operations. A powertrain of an electric vehicle includes a rechargeable energy storage system configured to provide power to a motor configured to drive the vehicle. The rechargeable energy storage system may be a single battery or multiple batteries configured to receive and transmit direct current (DC). The motor includes a rotor and a stator. The stator includes a plurality of windings or coils and the rotor is disposed within the stator and configured to rotate when the stator is energized. The motor is configured to operate by receiving an alternating current (AC). As such, the powertrain includes an inverter configured to transform the electrical power from the rechargeable energy storage system from DC to AC to power the motor.

The invertor is electrically coupled to the stator and transmits electric power in an AC waveform to different coil groups of the stator to induce a rotation of the rotor. The inverter includes a capacitor and the power conversion system includes dedicated hardware for performing pre-charge and discharge operations to limit an inrush current to the capacitor during start up. In particular, when the motor is started, the battery is placed in direct connection with the capacitor and there is a potential for an inrush of current from the battery to the capacitor. When the system is shut down, it is preferred to discharge the capacitor to prevent the capacitor from holding a charge over an unknown length of time.

Accordingly, it is desirable to have a power conversion system configured to perform pre-charge and discharge operations while eliminating the dedicated hardware. It is further desirable to have a power conversion system configured to perform pre-charge and discharge operations using a direct or inductive electric power transmission. It is further desirable to have a power conversion system wherein the rotor field windings and power electronics can be used for pre-charge and dis-charge operation with both contact and contactless power transfer systems to provide redundancy in the system.

### SUMMARY

One aspect of the disclosure provides an inverter configured to convert electric power from a direct current to an alternating current to provide electric power from a battery to a motor having a stator and a rotor. The inverter includes an electric line that couples a positive node of the battery to a negative node of the battery, and a rotor electric line that couples the electric line to the rotor. The inverter further includes a first relay, a second relay, a capacitor, and a charging circuit. The first relay is disposed on the electric line. The second relay is disposed on the rotor electric line and the capacitor is disposed on the electric line and is in parallel with the rotor. The charging circuit is electrically coupled to the rotor and is in parallel with the capacitor. The charging circuit includes a plurality of switches in parallel with each other, wherein one of the plurality of switches is connected to a first node of the rotor and another one of the plurality of switches is connected to a second node of the rotor. A controller is configured to execute a discharge operation. In the discharging operation, the first relay and the second relay are open to isolate the battery from the inverter and the plurality of switches are actuated to form an electric path for discharging the capacitor through the rotor.

Implementations of the disclosure include one or more of the following optional features. In some implementations, the controller is further configured to execute a pre-charging operation, wherein in the pre-charging operation the second relay is closed, the first relay is open, and the plurality of switches are actuated to form an electric path for charging the capacitor wherein electric power from the battery is transmitted to the capacitor through the rotor. The rotor provides a resistance limiting an inrush of current to the capacitor.

A plurality of switches may form an H-bridge converter. The H-bridge converter may be symmetric or asymmetric.

In some implementations, the inverter is inductively coupled to the rotor. In such an implementation, the charging circuit is configured to perform inductive power transfer utilizing one of a half-wave operation and a full-wave operation.

In some implementations, one of the plurality of switches and/or second relay is a bi-directional blocking switch.

In some implementations, the controller is configured to actuate the second relay in a closed and opened position during pre-charging operations to pulse-charge the capacitor until a voltage of the capacitor matches a voltage of the battery.

In some implementations, the controller is configured to actuate at least one of the plurality of switches to generate a pulse-width modulation signal configured to reduce the inrush of current to the capacitor.

Another aspect of the disclosure provides a power conversion system configured to convert electric power from direct current into alternating current. The power conversion system includes a battery, a motor, an electric line, a rotor electric line, an inverter and a controller. The battery includes a positive node and a negative node and is configured to transmit electric power in direct current. The motor includes a stator and a rotor including a first node and a second node for receiving and transmitting the electric power, wherein the stator is configured to be actuated by the electric power in alternating current to rotate the rotor. The electric line couples the positive node of the battery to the negative node of the battery. The rotor electric line includes a first end coupled to the electric line and a second end coupled to the rotor. The inverter includes a first relay, a second relay, a capacitor and a charging circuit. The first relay is disposed on the electric line and the second relay is disposed on the rotor electric line. The capacitor is connected the electric line and is in parallel with the rotor. The charging circuit is electrically coupled to the rotor and is in parallel with the capacitor. The charging circuit includes a plurality of switches in parallel with each other, wherein one of the plurality of switches is connected to the first node of the rotor and another one of the plurality of switches is connected to a second node of the rotor. The controller is configured to execute a pre-charging operation and a discharging operation, wherein in the pre-charging operation the second relay is closed, the first relay is open, and the plurality of switches are actuated to form an electric path for charging the capacitor wherein electric power from the battery is transmitted to the capacitor through the rotor. The rotor provides a resistance limiting an inrush of current to the capacitor. In a discharging operation, the second relay is open, and the first relay is open to isolate the battery from the inverter and the plurality of switches are actuated to form an electric path for discharging the capacitor through the rotor.

In some implementations, the plurality of switches forms an H-bridge converter. The H-bridge converter may be symmetric or asymmetric.

In some implementations, the inverter is coupled to the rotor using one of an inductive coil and a brush contact. In such an implementation, the charging circuit is configured to transform the electric power from the capacitor into alternating current to perform inductive power transfer.

In some implementations, the motor is a separately excited machine.

Yet another aspect of the disclosure provides an electric vehicle including a battery configured to power a motor for generating a driving force. The battery includes a positive node and a negative node and is further configured to transmit and receive electric power in direct current. The motor includes a stator and a rotor and is configured to be actuated by receiving electric power in alternating current, the rotor having a first node and a second node for receiving and transmitting the electric power. The electric vehicle includes an electric line, a rotor electric line, an inverter and a controller. The electric line couples the positive node of the battery to the negative node of the battery. The rotor electric line includes a first end coupled to the electric line and a second end coupled to the first node of the rotor. The inverter includes a first relay, a second relay, a capacitor and a charging circuit. The first relay is disposed on the electric line and the second relay is disposed on the rotor electric line. The capacitor is connected to the electric line and is in parallel with the rotor. The charging circuit is electrically coupled to the rotor and is in parallel with the capacitor. The charging circuit includes a plurality of switches in parallel with each other, wherein one of the plurality of switches is connected to the first node of the rotor and another one of the plurality of switches is connected to a second node of the rotor. The controller is configured to execute a pre-charging operation and a discharging operation. In the pre-charging operation, the second relay is closed, the first relay is open, and the plurality of switches are actuated to form an electric path for charging the capacitor wherein electric power from the battery is transmitted through the rotor to the capacitor. The rotor provides an impedance limiting an inrush of current to the capacitor. In the discharging operation, the second relay is open, and the first relay is open to isolate the battery from the inverter and the plurality of switches are actuated to form an electric path for discharging the capacitor through the rotor.

In some implementations, the plurality of switches forms an H-bridge converter. The H-bridge converter may be symmetric or asymmetric. In yet another implementation, the inverter is coupled to the rotor using one of an inductive coil and a brush contact.

In some implementations, the charging circuit is configured to transform the electric power from the battery into alternating current to perform inductive power transfer.

In some implementations, the controller is configured to actuate the second relay to pulse-charge the capacitor until a voltage of the capacitor matches a voltage of the battery.

### BRIEF DESCRIPTION OF THE DRAWINGS

The drawings described herein are for illustrative purposes only of selected configurations and are not intended to limit the scope of the present disclosure.

FIG. 1 is a perspective view of a vehicle showing a power conversion system;

FIG. 2 is a schematic view of the power conversion system shown in FIG. 1;

FIG. 3 is a schematic view of the power conversion system shown in FIG. 2 performing a discharging operation;

FIG. 4 is a schematic view of the power conversion system shown in FIG. 3 having an asymmetric H-bridge;

FIG. 5A is a schematic view of the power conversion system showing the inverter inductively coupled to the rotor and the electric path for generating a positive current during discharging operations;

FIG. 5B is a schematic view of the power conversion system of FIG. 5A showing the electric path for a generating a negative current during discharging operations;

FIG. 6A is a schematic view of a power conversion system configured to perform both a discharging operation and a pre-charging operation and the electric path of a discharging operation;

FIG. 6B is a schematic view of a power conversion system shown in FIG. 6A, showing the electric path of a pre-charging operation;

FIG. 7A is a schematic view of a power conversion system showing the inverter inductively coupled to the rotor and the electric path for generating a positive current during pre-charging operation;

FIG. 7B is a schematic view of FIG. 7A showing the electric path for generating a negative current during pre-charging operation;

FIG. 8A is a schematic view of the power conversion system of FIGS. 7A and 7B showing the electric path for generating a positive current during discharging operations; and

FIG. 8B is a schematic view of the power conversion system of FIG. 8A showing the electric path for a generating a negative current during discharging operations.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms “first,” “second,” “third,” etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

In this application, including the definitions below, the term “module” may be replaced with the term “circuit.” The term “module” may refer to, be part of, or include an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor (shared, dedicated, or group) that executes code; memory (shared, dedicated, or group) that stores code executed by a processor; other suitable hardware components that provide the described functionality; or a combination of some or all of the above, such as in a system-on-chip.

The term “code,” as used above, may include software, firmware, and/or microcode, and may refer to programs, routines, functions, classes, and/or objects. The term “shared processor” encompasses a single processor that executes some or all code from multiple modules. The term “group processor” encompasses a processor that, in combination with additional processors, executes some or all code from one or more modules. The term “shared memory” encompasses a single memory that stores some or all code from multiple modules. The term “group memory” encompasses a memory that, in combination with additional memories, stores some or all code from one or more modules. The term “memory” may be a subset of the term “computer-readable medium.” The term “computer-readable medium” does not encompass transitory electrical and electromagnetic signals propagating through a medium, and may therefore be considered tangible and non-transitory memory. Non-limiting examples of a non-transitory memory include a tangible computer readable medium including a nonvolatile memory, magnetic storage, and optical storage.

The apparatuses and methods described in this application may be partially or fully implemented by one or more computer programs executed by one or more processors. The computer programs include processor-executable instructions that are stored on at least one non-transitory tangible computer readable medium. The computer programs may also include and/or rely on stored data.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

The non-transitory memory may be physical devices used to store programs (e.g., sequences of instructions) or data (e.g., program state information) on a temporary or permanent basis for use by a computing device. The non-transitory memory may be volatile and/or non-volatile addressable semiconductor memory. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

The present disclosure relates to a power conversion system 10 including an inverter 12 for transforming electric power from a battery 14 to a motor 16 from a direct current (DC) to an alternating current (AC). The motor 16 includes a rotor 18 and a stator 20. The inverter 12 includes a capacitor 22 that requires a pre-charging operation and discharging operation to maintain the functionality of the inverter 12 and prevent damage to the electric components electrically coupled to the power conversion system 10. The inverter 12 includes a charging circuit 24 that is electrically coupled to the rotor 18 and generates electric paths through the rotor 18 to reduce an in-rush of current during pre-charging operations and discharge the capacitor 22 during discharging operations.

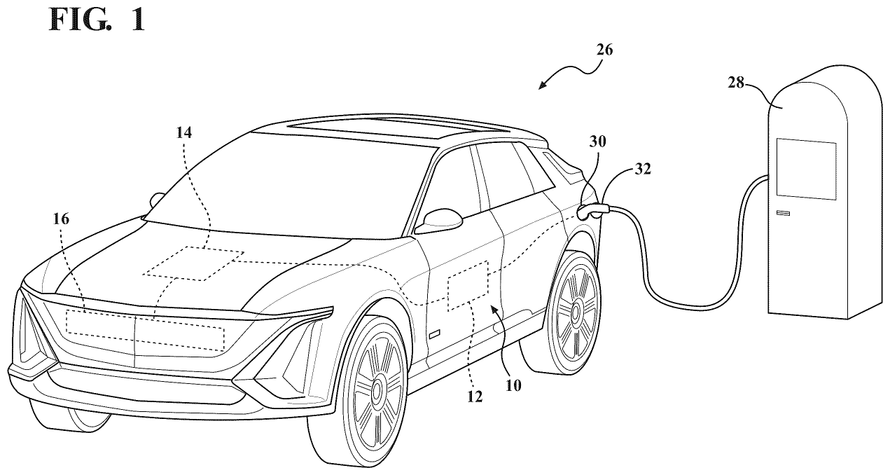

The power conversion system 10 may be implemented in any platform or device that utilizes a battery 14 to power a motor 16. For illustrative purposes, the power conversion system 10 is described in the context of an electric vehicle 26 as shown in FIG. 1. However, it should be appreciated that the power conversion system 10 may be implemented in other devices/platforms illustratively including a boat, a motorcycle, a residential or commercial building and the like.

FIG. 1 depicts the vehicle 26 coupled to a first power source 28. In particular the vehicle 26 includes a charging inlet 30 and the first power source 28 includes a charger 32 configured to couple with the charging inlet 30 to provide power to charge the battery 14. The first power source 28 is illustratively shown as a commercial charging station, but it should be appreciated that the first power source 28 may be a residential outlet as well. The vehicle 26 is an electric vehicle 26 having a battery 14 configured to receive a charge from the first power source 28 and to power the motor 16 for driving the vehicle 26.

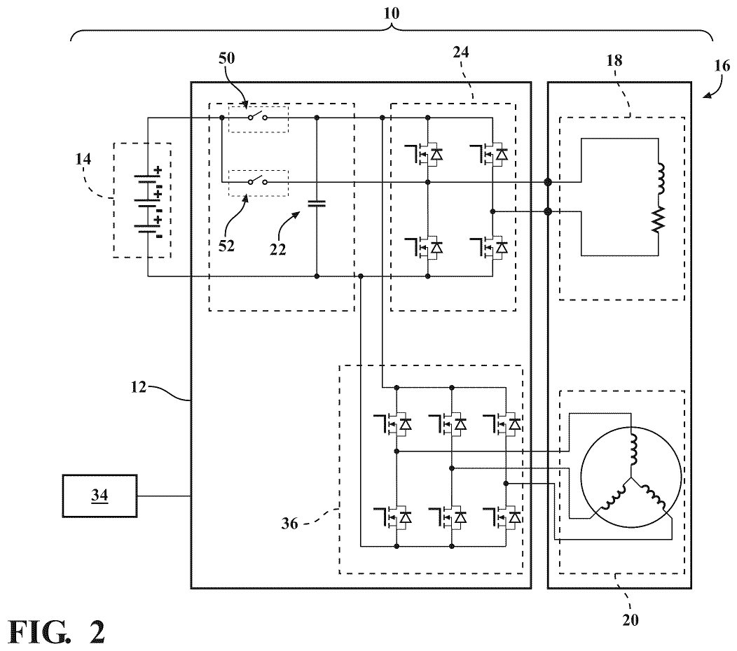

With reference now to FIG. 2, the power conversion system 10 includes the inverter 12, the battery 14, the motor 16, and a controller 34. The motor 16 may be a three-phase inductive motor configured to generate as much as 200 horsepower to drive the vehicle 26. For instance, the motor 16 may be what is referred to in the art as a Separately Excited Machine (SEM). The stator 20 is configured to receive three phases of electric power in AC, which rotates the rotor 18. The motor 16 may include electronics for controlling the operation of the stator 20 and the rotor 18, any inductive motor currently known or later developed may be adapted for use herein, illustratively including a motor 16 commonly known as a SEM.

The battery 14 is configured to be rechargeable and is further configured to power the motor 16. Any battery 14 configured to be charged with electrical power currently known or later developed may be modified for use herein, illustratively including lithium-ion batteries, solid state batteries, and the like. The capacity of the battery 14 need not be limiting and may include batteries having a capacity greater than 30 kilowatts (kW). The battery 14 is further configured to power the various electronic components within the vehicle 26. Such electronic components are well known and illustratively include lights, windshield wipers, a head unit, a heating, ventilating, and air conditioning (HVAC) unit, and the like.

The inverter 12 is interposed between the battery 14 and the motor 16. The inverter 12 is configured to transform the DC electric power from the battery 14 into AC electric power for transmission to the motor 16. Specifically, the inverter 12 is configured to transform DC electric power from the battery 14 to AC electric power and supply the AC electric power to the stator 20. The inverter 12 may include a stator circuit 36 configured to separate the electric power into three phases which is transmitted to a respective coil of the stator 20 (represented schematically by inductors) to rotate the rotor 18 through induction. The rotor 18 is formed of windings wound around a cage (not shown) as represented schematically by an inductor and a resistor. The charging circuit 24 of the inverter 12 is electrically coupled to the rotor 18. The charging circuit 24 receives DC electric power from the battery 14 and/or the capacitor 22, as discussed in more detail below. The controller 34 is electrically coupled to the inverter 12 and is configured to transmit instructions to the inverter 12 to perform pre-charging operations and discharging operations.

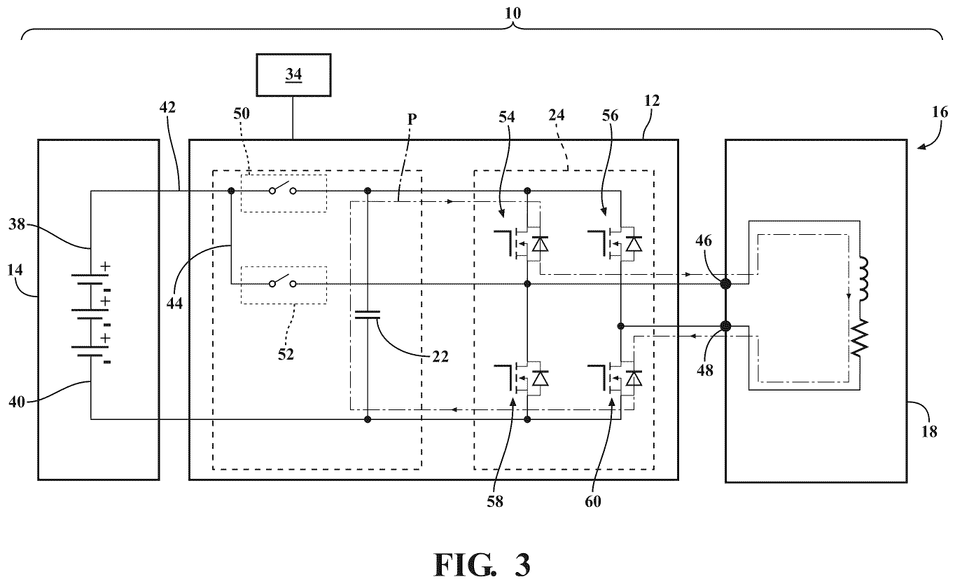

With reference now to FIG. 3 a schematic showing the inverter 12 coupled to the rotor 18 of the motor 16 and the battery 14 is provided. The battery 14 includes a positive node 38 and a negative node 40, and an electric line 42 couples the positive node 38 to the negative node 40. A rotor electric line 44 is attached to the electric line 42 on one end and is coupled to a first node 46 of the rotor 18 at another end. A second node 48 of the rotor 18 is attached to the electric line 42 to complete an electric path between the inverter 12 and the rotor 18. The electric line 42 and the rotor electric line 44 may be formed of any conductive material configured to transmit electrical power such as a bus bar, a braided cable or the like.

The inverter 12 further includes a first relay 50 and a second relay 52. The first relay 50 is disposed on the electric line 42 and is interposed between the battery 14 and the charging circuit 24. The second relay 52 is disposed on the rotor electric line 44 to be in parallel with the first relay 50 and interposed between the battery 14 and the rotor 18. The capacitor 22 is interposed between the first relay 50 and the charging circuit 24 and is connected in parallel with both the charging circuit 24 and the rotor 18. The capacitor 22 is configured to hold a voltage that matches a voltage of the battery 14. Any capacitor 22 configured to match the voltage of the battery 14 currently known or later developed may be adapted for use herein, illustratively including a capacitor 22 commonly known as a DC Link capacitor.

The charging circuit 24 is electrically coupled to the rotor 18 and in parallel with the capacitor 22. The charging circuit 24 includes a plurality of switches 54, 56, 58, 60 that are arranged in parallel with each other. For illustrative purposes, the charging circuit 24 includes a first switch 54, a second switch 56, a third switch 58 and a fourth switch 60. The switches 54, 56, 58, 60 are shown as a directional Metal-Oxide Semiconductor Field-Effect Transistor (MOSFET) switch, wherein first switch 54 and the second switch 56 are connected in parallel with each other and the third switch 58 and the fourth switch 60 are connected in parallel to each other. The first switch 54 is connected to the first node 46 of the rotor 18 and the fourth switch 60 is connected to the second node 48 of the rotor 18.

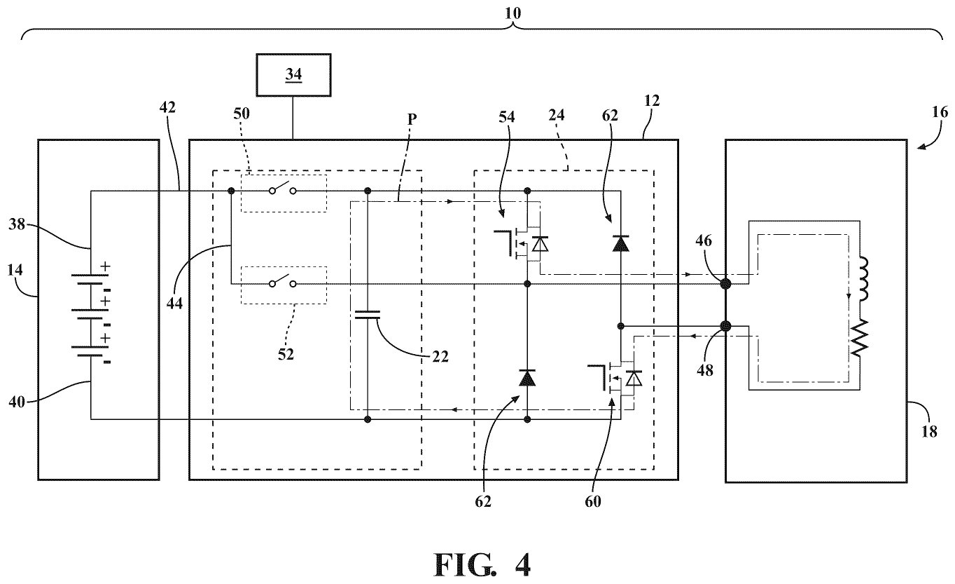

FIG. 3 depicts an aspect where the plurality of switches defines an H-bridge converter that is symmetric, meaning that a pair consisting of the first switch 54 and the second switch 56 are placed in parallel with another pair consisting of the third switch 58 and the fourth switch 60. FIG. 4 depicts an aspect where the first switch 54 and the fourth switch 60 form an asymmetric H-bridge converter. In such an aspect, the second switch 56 and the third switch 58 are replaced with a corresponding first diode 62 and second diode 64.

The controller 34 is configured to control the inverter 12 and actuate the charging circuit 24 to execute a discharging operation, wherein in the discharging operation, the first relay 50 and second relay 52 are open to isolate the battery 14 from the inverter 12 and the plurality of switches 54, 56, 58, 60 are actuated to form an electric path for discharging the capacitor 22 through the rotor 18. The controller 34 may be integrated as a single unit with the inverter 12 or may be a separate unit electrically coupled to the inverter 12 as shown in the figures. The controller 34 may be a processing unit including a non-volatile storage medium storing instructions which when processed by the processing unit executes predetermined functions.

In one aspect, the discharging operation is configured to create an electric path for discharging the voltage of the capacitor 22 to the rotor 18. For instance, when the motor 16 is turned off, it is desirable to discharge the voltage held within the capacitor 22 to prevent electrical interference with other components within the electric vehicle 26, reduce stress on the components of the system, and reduce the risk of a high voltage exposure. As such, the discharging operation is performed when the motor 16 is turned off. During discharging operations, the controller 34 opens the first relay 50 and the second relay 52 to isolate the inverter 12 and the rotor 18 from the battery 14. The controller 34 instructs the first switch 54 and the fourth switch 60 to close and the second switch 56 and the third switch 58 to open. As such, an electric path “P”, as indicated by the dashed lines and arrow is formed wherein the voltage held in the capacitor 22 is discharged through the windings of the rotor 18.

FIG. 4 shows a discharging operation in an asymmetric H-bridge converter, in which case the first relay 50 and the second relay 52 are opened, again isolating the inverter 12 and the rotor 18 from the battery 14. The first switch 54 and the fourth switch 60 are closed and the first diode 62 directs a discharge from the capacitor 22 to the first node 46 of the rotor 18 to dissipate the voltage along the electrical path “P” indicated by dashed lines and arrows.

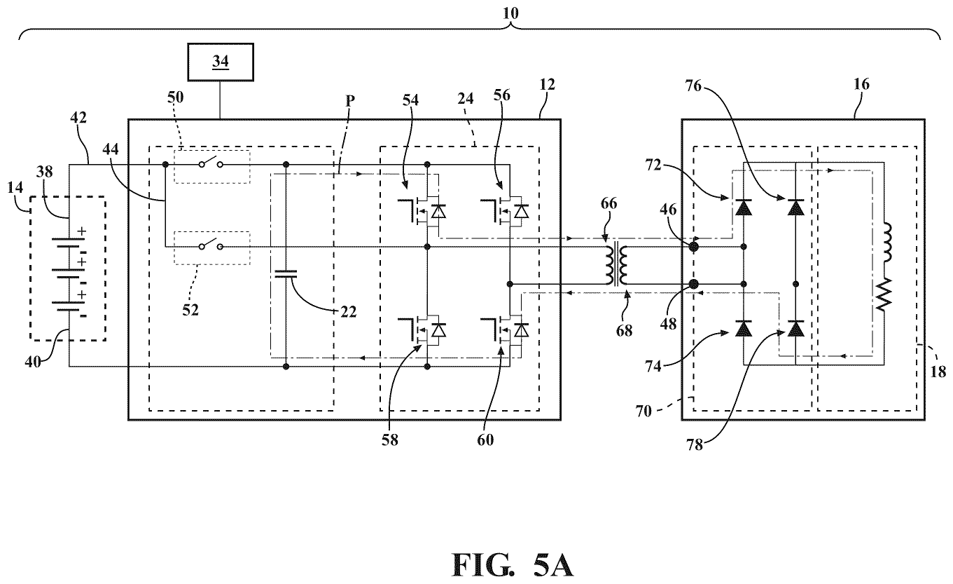

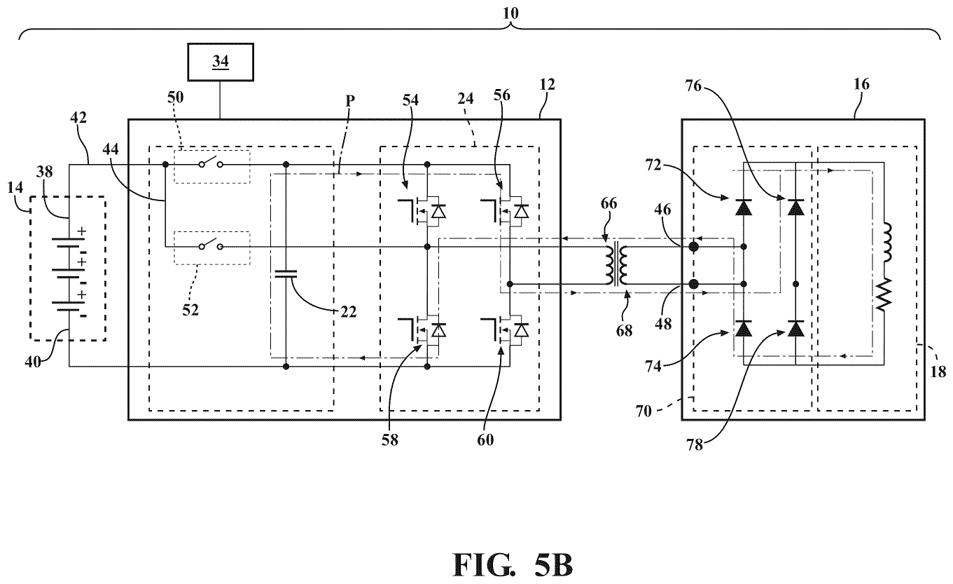

FIGS. 3 and 4 illustrate an aspect where the inverter 12 is coupled to the rotor 18 through a direct electric connection such as a brush or a wire. However, it should be appreciated that the inverter 12 may be coupled to the rotor 18 through an electric induction, as shown in FIGS. 5A and 5B. As the electric power from the capacitor 22 and the battery 14 is DC, the electric power may be directly transmitted to the rotor 18. The rotor 18 includes windings, which define an inductor and a resistance and, thus, electric power transmitted through the rotor is dissipated.

FIGS. 5A and 5B depicts a discharging operation using an inductive connection between the inverter 12 and the rotor 18. The inverter 12 includes a first inductive coil 66 and the rotor 18 includes a second inductive coil 68 that are spaced apart from each other. The rotor 18 is further configured with a rectifier 70. The rectifier 70 includes a third diode 72, a fourth diode 74, a fifth diode 76 and a sixth diode 78. The third diode 72 and the fourth diode 74 are connected in parallel with each other and the fifth diode 76 and the sixth diode 78 are connected in parallel with each other, wherein the rectifier 70 transforms the AC electric power to DC electric power.

The power transfer between the first inductive coil 66 and the second inductive coil 68 requires AC electric power. However, the power discharged from the capacitor 22 is DC electric power. The controller 34 is configured to open and close the second switch 56 and the fourth switch 60 in an alternating manner to generate AC electric power.

FIG. 5A shows the first switch 54 and the fourth switch 60 closed and the second switch 56 and the third switch 58 opened thus a positive DC current is supplied to the first inductive coil 66. FIG. 5B shows the second switch 56 and the third switch 58 closed and the first switch 54 and the fourth switch 60 opened thus a negative current is supplied to the first inductive coil 66. The controller 34 alternates the opening and closing the second switch 56 and the fourth switch 60 to provide a positive and negative current to form the AC electric power required to couple the first inductive coil 66 to the second inductive coil 68. The AC power received by the second inductive coil 68 is then transformed into DC electric power by the rectifier 70 to discharge the capacitor 22 through the rotor 18.

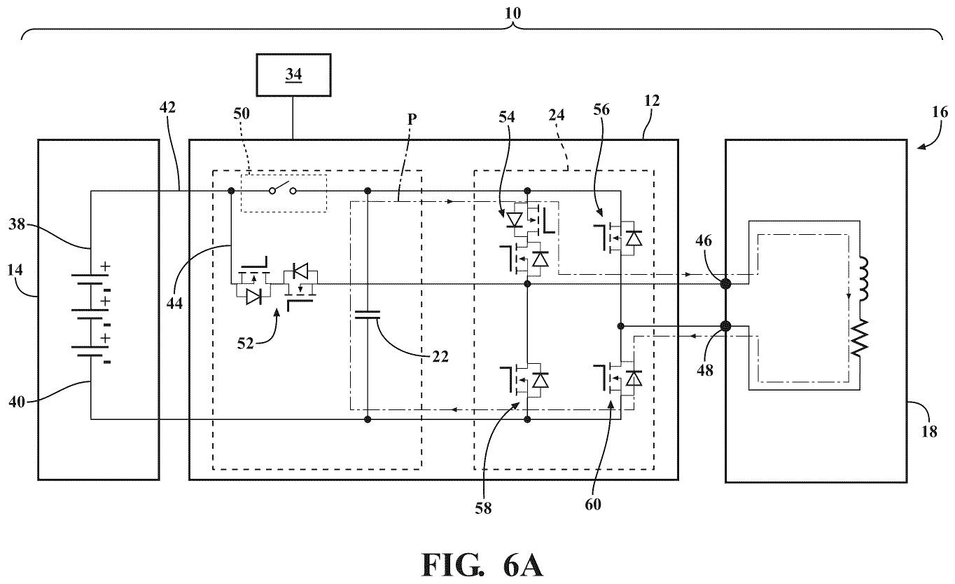

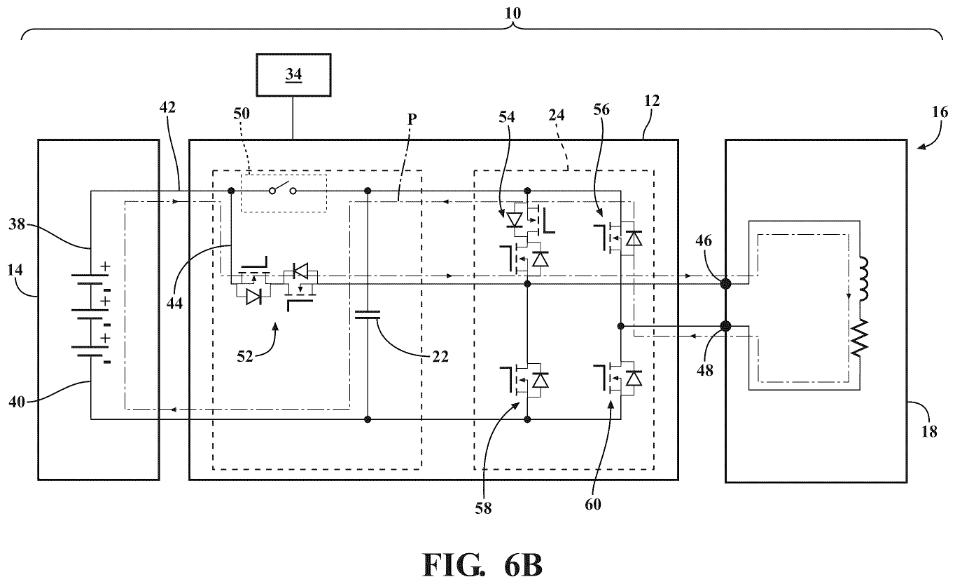

With reference now to FIGS. 6A and 6B, in one aspect of a power conversion system 10, the inverter 12 is further configured to perform both a pre-charging operation and the discharging operation. In such an aspect, the inverter 12 includes a bidirectional blocking switch. In particular, the second relay 52 and the first switch 54 are bidirectional blocking switches. FIG. 6A depicts the inverter 12 performing a discharging operation, wherein the first relay 50 and the second relay 52 are opened to isolate the inverter 12 and the rotor 18 from the battery 14. The first switch 54 and the fourth switch 60 are closed and the second switch 56 and the third switch 58 are opened. Thus, a voltage of the capacitor 22 is discharged through the rotor 18 along the electric path “P” indicated in dashed lines and arrows. Specifically, electric power is transmitted to the rotor 18 through the first node 46 and is dissipated in part by the inductance and resistance of the rotor 18 and passed through the second node 48 back to the capacitor 22 until the voltage of the capacitor 22 is dissipated.

FIG. 6B depicts the inverter 12 performing a pre-charging operation. The pre-charging operation is useful prior to actuation of the motor 16 and limits an inrush of current to the capacitor 22 to prevent power surges in the system as well as preserve the life and integrity of the capacitor 22 itself. During pre-charging operations, the controller 34 closes the second relay 52 and opens the first relay 50. As such, electric power from the battery 14 is supplied to the rotor 18 along an electric path “P” that extends along the rotor electric line 44 through the first node 46 of the rotor 18 where an inrush of power from the battery 14 is mitigated through the resistance of the winding of the rotor 18. The reduced electric power is then transmitted through the second node 48 of the rotor 18 through the second switch 56 and to the capacitor 22, as indicated by dashed line and arrows. The controller 34 may further actuate the second relay 52 in a closed and opened position during pre-charging operations to pulse-charge the capacitor 22 until a voltage of the capacitor 22 matches a voltage of the battery 14. The controller 34 may be further configured to actuate any one of the first switch 54, the second switch 56, the third switch 58 and the fourth switch 60 to generate a pulse-width modulation signal that reduces the inrush of current to the capacitor 22.

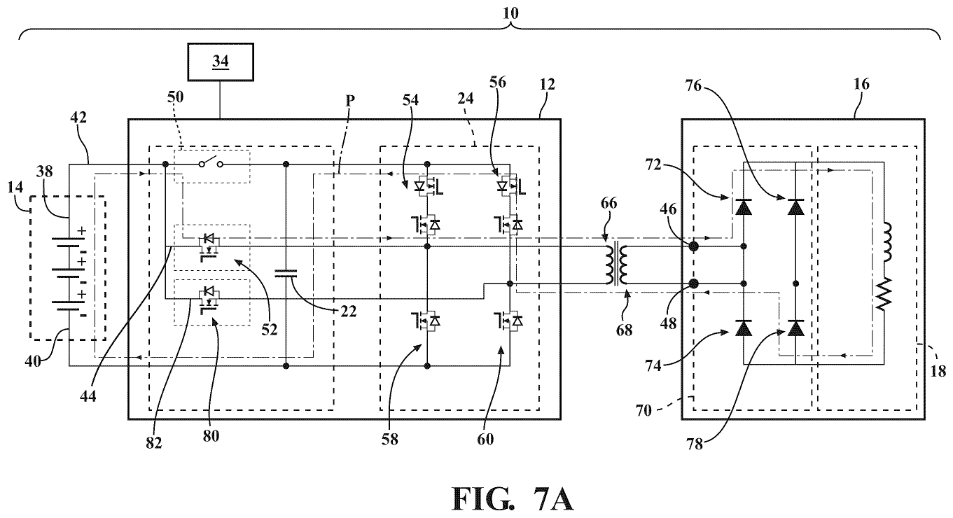

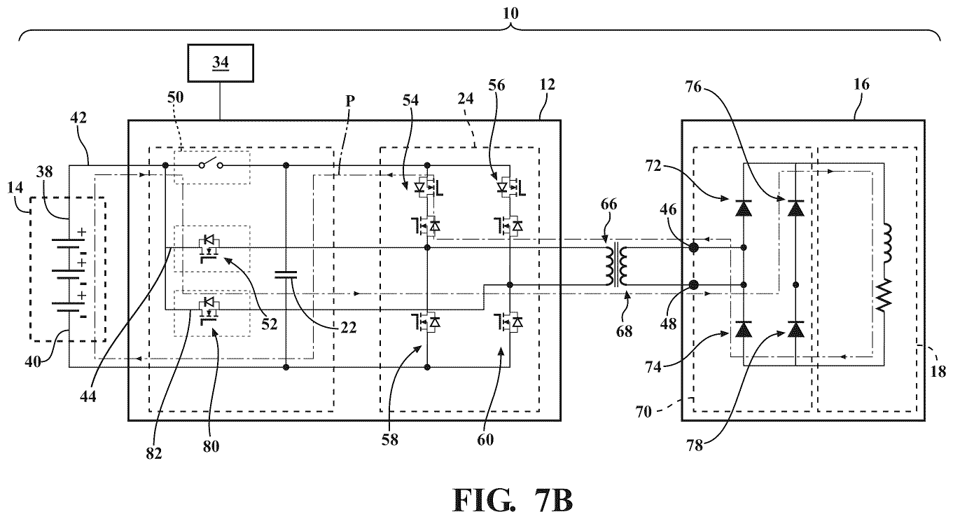

FIGS. 7A and 7B disclose an aspect of an inverter 12 configured to perform pre-charging operations when the inverter 12 is inductively coupled to the rotor 18. The inverter 12 includes a first inductive coil 66 and the rotor 18 includes a second inductive coil 68 that are spaced apart from each other. The rotor 18 is further configured with a rectifier 70. The inverter 12 is further configured to transform the DC electric power from the battery 14 to AC electric power to perform the inductive power transfer between the first inductive coil 66 and the second inductive coil 68. For example, the inverter 12 may include a third relay 80 and a second rotor electric line 82. The third relay 80 is in parallel with the second relay 52. The second switch 56 is configured as a bidirectional MOSFET.

FIG. 7A shows the second relay 52 closed and the first relay 50 and the third relay 80 opened. The first switch 54 and the second switch 56 are closed and the third switch 58 and the fourth switch 60 are opened, thus a positive DC current is supplied to the first inductive coil 66. FIG. 7B shows the first relay 50 and the second relay 52 opened, the third relay 80 closed, and the second switch 56, the third switch 58 and the fourth switch 60 are opened while the first switch 54 is closed, thus a negative current is supplied to the first inductive coil 66. The controller 34 alternates the actuation of the second relay 52, the third relay 80, the first switch 54, the second switch 56, the third switch 58 and the fourth switch 60 between the positions shown in FIGS. 7A and 7B to transform the DC electric power into AC electric power by generating a positive and negative current to couple the first inductive coil 66 to the second inductive coil 68 and initiate an inductive power transfer to the rotor 18. The AC power received by the second inductive coil 68 is then transformed into DC electric power by the rectifier 70 to transmit the power from the battery 14 through the rotor 18 and limit an inrush of current to the capacitor 22. Though the figures show an aspect where the inverter 12 includes a single capacitor 22, it should be appreciated that the operation described herein may be applicable for pre-charging a high voltage capacitor (not shown) that is connected in parallel with the inverter 12. For instance, the operations described herein may be used to charge a high-voltage capacitor that is part of another electrical unit such as an on-board charger, a low voltage battery charger or the like.

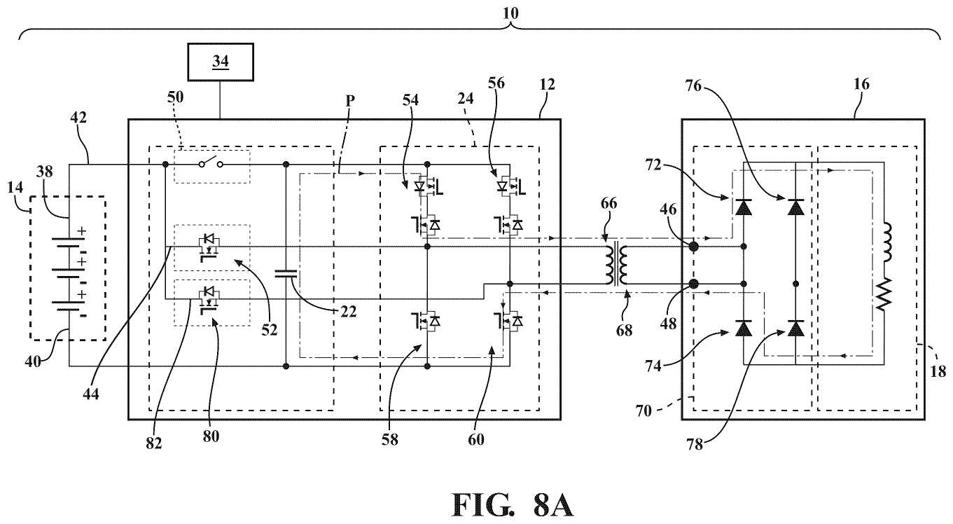

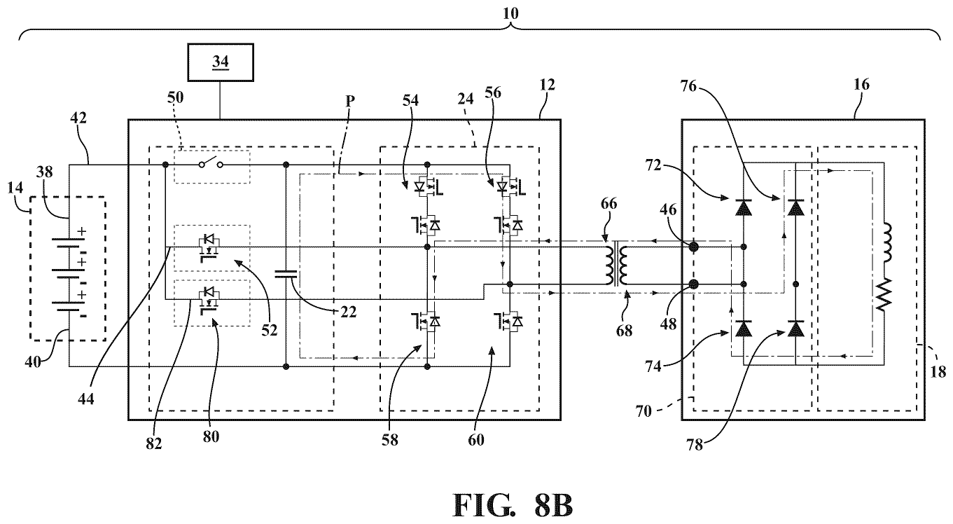

With reference now to FIGS. 8A and 8B, the inverter 12 is shown performing a discharging operation. FIGS. 8A and 8B depict a discharging operation using an inductive connection between the inverter 12 and the rotor 18. The controller 34 is configured to open the first relay 50, the second relay 52 and the third relay 80 to isolate the inverter 12 and the rotor 18 from the battery 14. The controller 34 is further configured to open and close the second switch 56 and the fourth switch 60 in an alternating manner to generate AC electric power. FIG. 8A shows the first switch 54 and the fourth switch 60 closed and the second switch 56 and the third switch 58 are opened thus a positive DC current is supplied to the first inductive coil 66. FIG. 8B shows the second switch 56 and the third switch 58 closed and the first switch 54 and the fourth switch 60 open thus a negative current is supplied to the first inductive coil 66. The controller 34 alternates the opening and closing the second switch 56 and the fourth switch 60 to provide a positive and negative current to form the AC electric power required to couple the first inductive coil 66 to the second inductive coil 68. The AC power received by the second inductive coil 68 is then transformed into DC electric power by the rectifier 70 to discharge the capacitor 22 through the rotor 18.

A number of implementations have been described. Nevertheless, it will be understood that various modifications may be made without departing from the spirit and scope of the disclosure. Accordingly, other implementations are within the scope of the following claims.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. An inverter configured to convert electric power from a direct current to an alternating current to provide electric power from a battery to a motor having a stator and a rotor, the inverter comprising:
an electric line couples a positive node of the battery to a negative node of the battery, and a rotor electric line couples the electric line to the rotor;
a first relay disposed on the electric line;
a second relay disposed on the rotor electric line;
a capacitor disposed on the electric line and in parallel with the rotor;
a charging circuit electrically coupled to the rotor and in parallel with the capacitor, the charging circuit including a plurality of switches in parallel with each other, wherein one of the plurality of switches is connected to a first node of the rotor and another one of the plurality of switches is connected to a second node of the rotor; and
a controller configured to actuate the charging circuit to execute a discharging operation, wherein in the discharging operation, the second relay and the first relay are open to isolate the battery from the inverter and the plurality of switches are actuated to form an electric path for discharging the capacitor through the rotor.

2. The inverter as set forth in claim 1, wherein the controller is further configured to actuate the charging circuit to execute a pre-charging operation, in the pre-charging operation the second relay is closed, the first relay is open and the plurality of switches are actuated to form an electric path for charging the capacitor wherein electric power from the battery is transmitted to the capacitor through the rotor, the rotor providing a resistance limiting an inrush of current to the capacitor.

3. The inverter as set forth in claim 2, wherein the plurality of switches forms an H-bridge converter.

4. The inverter as set forth in claim 1, wherein the inverter is inductively coupled to the rotor.

5. The inverter as set forth in claim 4, wherein the charging circuit is configured to transform the electric power from the battery into alternating current to perform inductive power transfer.

6. The inverter as set forth in claim 1, wherein one of the plurality of switches and/or second relay is a bi-directional blocking switch.

7. The inverter as set forth in claim 1, wherein the controller is configured to actuate the second relay in a closed and opened position during pre-charging operations to pulse-charge the capacitor until a voltage of the capacitor matches a voltage of the battery.

8. The inverter as set forth in claim 2, wherein the controller is configured to actuate at least one of the plurality of switches to generate a pulse-width modulation signal configured to reduce the inrush of current to the capacitor.

9. A power conversion system configured to convert electric power from direct current into alternating current, the power conversion system comprising:
a battery configured to transmit and receive the electric power in direct current, the battery having a positive node and a negative node;
a motor having a stator and a rotor, the rotor having a first node and a second node for receiving and transmitting the electric power, wherein the stator is configured to receive electric power in alternating current to rotate the rotor; and
an electric line couples the positive node of the battery to the negative node of the battery;
a rotor electric line having a first end coupled to the electric line and a second end coupled to the rotor;
an inverter including a first relay, a second relay, a capacitor and a charging circuit, wherein the first relay is disposed on the electric line, the second relay disposed on the rotor electric line, the capacitor is connected the electric line and in parallel with the rotor, and wherein the charging circuit is electrically coupled to the rotor and in parallel with the capacitor, the charging circuit including a plurality of switches in parallel with each other, wherein one of the plurality of switches is connected to the first node of the rotor and another one of the plurality of switches is connected to a second node of the rotor; and
a controller configured to actuate the charging circuit to execute a pre-charging operation and a discharging operation, wherein in the pre-charging operation the second relay is closed, the first relay is open and the plurality of switches are actuated to form an electric path for charging the capacitor wherein electric power from the battery is transmitted to the capacitor through the rotor, the rotor providing a resistance limiting an inrush of current to the capacitor and in the discharging operation, the second relay is open and the first relay is open to isolate the battery from the inverter and the plurality of switches are actuated to form an electric path for discharging the capacitor through the rotor.

10. The power conversion system as set forth in claim 9, wherein the plurality of switches forms an H-bridge converter.

11. The power conversion system as set forth in claim 10, wherein the H-bridge converter is asymmetric.

12. The power conversion system as set forth in claim 9, wherein the inverter is coupled to the rotor using one of an inductive coil and a brush contact.

13. The power conversion system as set forth in claim 12, wherein the charging circuit is configured to transform the electric power from the capacitor into alternating current to perform inductive power transfer.

14. The power conversion system as set forth in claim 9, wherein the motor is a separately excited machine.

15. An electric vehicle including a battery configured to transmit and receive electric power in direct current, the battery having a positive node and a negative node and configured to power a motor for generating a driving force, the motor having a stator and a rotor, the motor to be actuated by receiving electric power in alternating current, the rotor having a first node and a second node for receiving and transmitting the electric power, the electric vehicle comprising:
an electric line couples the positive node of the battery to the negative node of the battery;
a rotor electric line having a first end coupled to the electric line and a second end coupled to the first node of the rotor;
an inverter including a first relay, a second relay, a capacitor and a charging circuit, wherein the first relay is disposed on the electric line, the second relay disposed on the rotor electric line, the capacitor is connected to the electric line and is in parallel with the rotor, and wherein the charging circuit is electrically coupled to the rotor and in parallel with the capacitor, the charging circuit including a plurality of switches in parallel with each other, wherein one of the plurality of switches is connected to the first node of the rotor and another one of the plurality of switches is connected to a second node of the rotor; and
a controller configured to execute a pre-charging operation and a discharging operation, wherein in the pre-charging operation the second relay is closed, the first relay is open and the plurality of switches are actuated to form an electric path for charging the capacitor wherein electric power from the battery is transmitted to the capacitor through the rotor, the rotor providing a resistance limiting an inrush of current to the capacitor and in the discharging operation, the second relay is open and the first relay is open to isolate the battery from the inverter and the plurality of switches are actuated to form an electric path for discharging the capacitor through the rotor.

16. The electric vehicle as set forth in claim 15, wherein the plurality of switches forms an H-bridge converter.

17. The electric vehicle as set forth in claim 16, wherein the H-bridge converter is asymmetric.

18. The electric vehicle as set forth in claim 15, wherein the inverter is coupled to the rotor using one of an inductive coil and a brush contact.

19. The electric vehicle as set forth in claim 18, wherein the charging circuit is configured to transform the electric power from the battery into alternating current to perform inductive power transfer.

20. The electric vehicle as set forth in claim 15, wherein the controller is configured to actuate the second relay to pulse-charge the capacitor until a voltage of the capacitor matches a voltage of the battery.
